(19) United States
(12) Patent Application Publication
(10) Pub. No.: US 2019/0301867 A1
(43) Pub. Date: Oct. 3, 2019

(54) VIBRATING ELEMENT, PHYSICAL QUANTITY SENSOR, INERTIAL MEASUREMENT DEVICE, ELECTRONIC APPARATUS, VEHICLE, AND METHOD OF MANUFACTURING VIBRATING ELEMENT

(71) Applicant: Seiko Epson Corporation, Tokyo (JP)

(72) Inventors: Shogo SASAKI, Shiojiri (JP); Masashi SHIMURA, Chino (JP); Keiichi YAMAGUCHI, Ina (JP); Masahiro OSHIO, Shiojiri (JP)

(21) Appl. No.: 16/369,025

(22) Filed: Mar. 29, 2019

(30) Foreign Application Priority Data
Mar. 30, 2018 (JP) 2018-067110

(51) Int. Cl. G01C 19/5628; G01C 19/5769

(52) U.S. Cl. CPC G01C 19/5628; G01C 19/5769

(57) ABSTRACT

A vibrating element includes a base, a vibrating arm extending from the base, and having an arm section provided with an electrode film, and a weight section, a weight film provided to the weight section, and the vibrating arm has a first principal surface and a second principal surface in an obverse-reverse relationship, the electrode film and the weight film are disposed on the first principal surface and the second principal surface, and a thickness of the electrode film disposed on the first principal surface, a thickness of the weight film disposed on the first principal surface, a thickness of the electrode film disposed on the second principal surface, and a thickness of the weight film disposed on the second principal surface are each no less than 50 nm and no more than 500 nm.

The present application is based on, and claims priority from Japanese Patent Application Serial Number 2018-067110, filed Mar. 30, 2018, the disclosure of which is hereby incorporated by reference herein in its entirety.

### BACKGROUND

### 1. Technical Field

The present disclosure relates to a vibrating element, a physical quantity sensor, an inertial measurement device, an electronic apparatus, a vehicle, and a method of manufacturing a vibrating element.

### 2. Related Art

In the past, there has been known a vibrating element used for a device such as a quartz crystal vibrator or a vibration gyro sensor. The tuning-fork quartz crystal vibrator element described in JP-A-2006-311444 (Document 1) as an example of such a vibrating element is provided with a base, and a pair of vibrating arms extending in parallel to each other from the base separated from the base like a fork. Here, on the obverse and reverse surfaces of the vibrating arms, there are formed excitation electrodes and weights. By inputting drive voltage to the excitation electrodes, it is possible to cause an electric field in the vibrating arms to thereby vibrate the vibrating arms.

Further, in the tuning-fork quartz crystal vibrator element described in Document 1, the excitation electrode is disposed on the entire obverse surface of a tip area of the vibrating arm on the one hand, and the weight is stacked in addition to the excitation electrode on the reverse surface of the tip area on the other hand. When the weight is irradiated with a laser, the mass decreases, and thus, it is possible to adjust the frequency of the vibration.

However, in the tuning-fork quartz crystal vibrator element described in Document 1, the excitation electrode and the weight are individually disposed. Therefore, when manufacturing such a quartz crystal vibrator element, it is necessary to individually perform a process of forming the excitation electrode and a process of forming the weight. Therefore, the number of manufacturing processes increases to incur deterioration of the manufacturing efficiency and rise in manufacturing cost.

### SUMMARY

An advantage of some aspects of the present disclosure is to solve at least a part of the problem described above, and the present disclosure can be implemented as the following application examples or aspects.

A vibrating element according to an application example includes a base, a vibrating arm extending from the base, and having an arm section, a weight section, and a first principal surface and a second principal surface in an obverse-reverse relationship, an electrode film disposed on each of the first principal surface and the second principal surface in the arm section, and having a thickness no less than 50 nm and no more than 500 nm, and a weight film disposed on each of the first principal surface and the second principal surface in the weight section, and having a thickness no less than 50 nm and no more than 500 nm.

### BRIEF DESCRIPTION OF THE DRAWINGS

FIG. 1 is a plan view showing a vibrating element according to a first embodiment of the present disclosure.

FIG. 2 is a cross-sectional view along the line A-A in FIG. 1.

FIG. 3 is a plan view showing the neighborhood of the weight section of a vibrating arm (a drive arm) of the vibrating element in an enlarged manner.

FIG. 4 is a cross-sectional view along the line B-B in FIG. 3.

FIG. 5 is a cross-sectional view along the line C-C in FIG. 3.

FIG. 6 is a flowchart showing a method of manufacturing the vibrating element according to the first embodiment.

FIG. 7 is a cross-sectional view for explaining a film forming process of forming electrode films and a weight film on the vibrating arm in the method of manufacturing the vibrating element according to the first embodiment.

FIG. 8 is a cross-sectional view for explaining the film forming process of forming the electrode films and the weight film on the vibrating arm in the method of manufacturing the vibrating element according to the first embodiment.

FIG. 9 is a cross-sectional view for explaining a frequency adjustment process in the method of manufacturing the vibrating element according to the first embodiment.

FIG. 10 is a cross-sectional view for explaining the frequency adjustment process in an example in which the method of manufacturing the vibrating element according to the first embodiment is partially changed.

FIG. 11 is a cross-sectional view for explaining the frequency adjustment process in the example in which the method of manufacturing the vibrating element according to the first embodiment is partially changed.

FIG. 12 is a plan view showing a vibrating element according to a second embodiment of the present disclosure.

FIG. 13 is a plan view showing a vibrating element according to a third embodiment of the present disclosure.

FIG. 14 is a cross-sectional view showing a physical quantity sensor according to an embodiment of the present disclosure.

FIG. 15 is an exploded perspective view showing an embodiment of an inertial measurement device according to the present disclosure.

FIG. 16 is a perspective view of a board provided to the inertial measurement device shown in FIG. 15.

FIG. 17 is a perspective view showing an embodiment (a mobile type personal computer) of the electronic apparatus according to the present disclosure.

FIG. 18 is a plan view showing an embodiment (a mobile phone) of the electronic apparatus according to the present disclosure.

FIG. 19 is a perspective view showing an embodiment (a digital still camera) of the electronic apparatus according to the present disclosure.

FIG. 20 is a perspective view showing an embodiment (a car) of a vehicle according to the present disclosure.

### DESCRIPTION OF EXEMPLARY EMBODIMENTS

Hereinafter, a vibrating element, a method of manufacturing a vibrating element, a physical quantity sensor, an inertial measurement device, an electronic apparatus and a vehicle according to the present disclosure will be described in detail based on the embodiments shown in the accompanying drawings.

### 1. Vibrating Element and Method of Manufacturing Vibrating Element

### First Embodiment

Firstly, the vibrating element and the method of manufacturing the vibrating element according to a first embodiment will be described.

### Vibrating Element

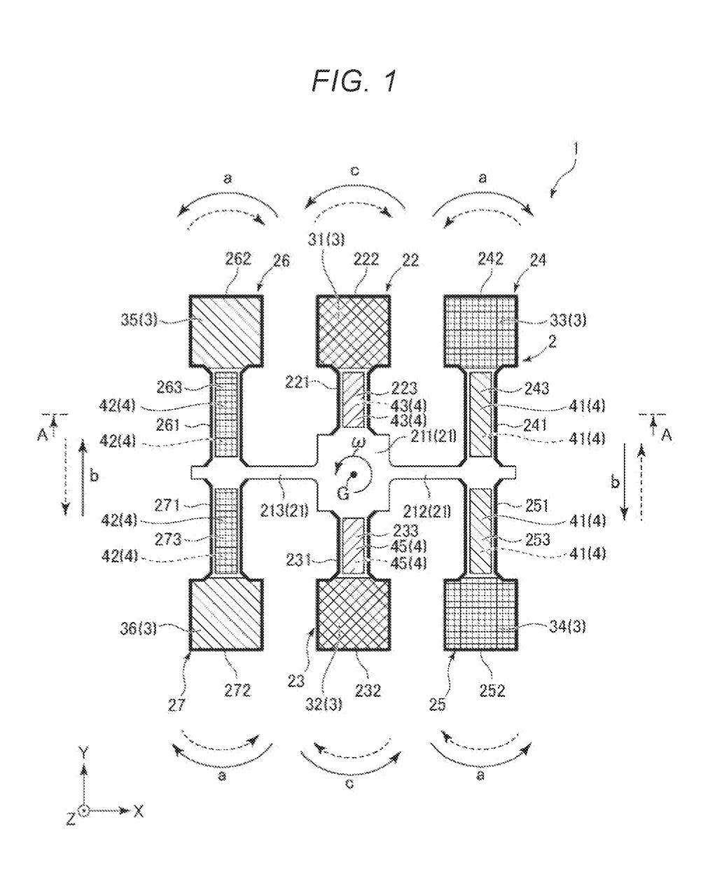

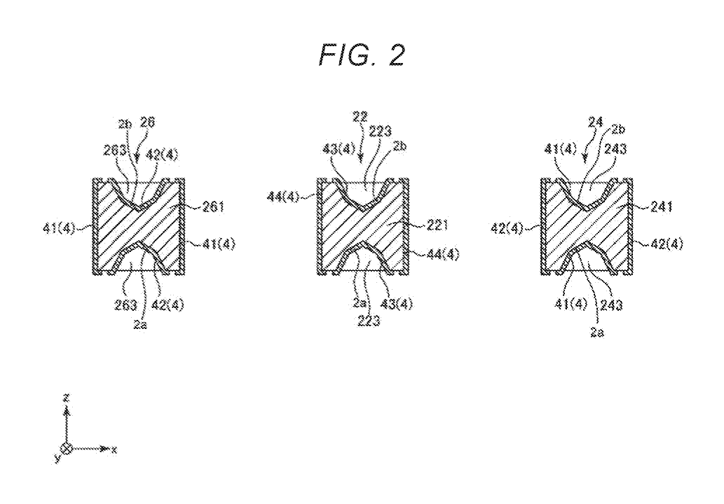

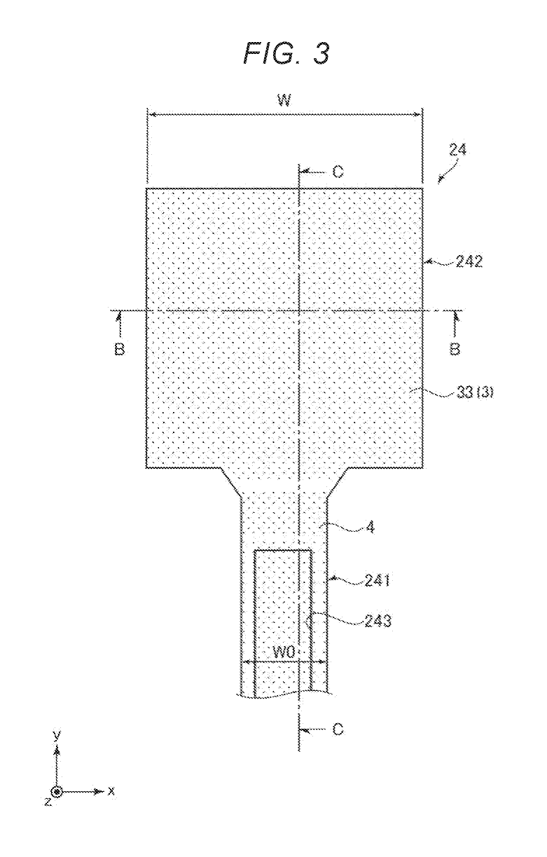

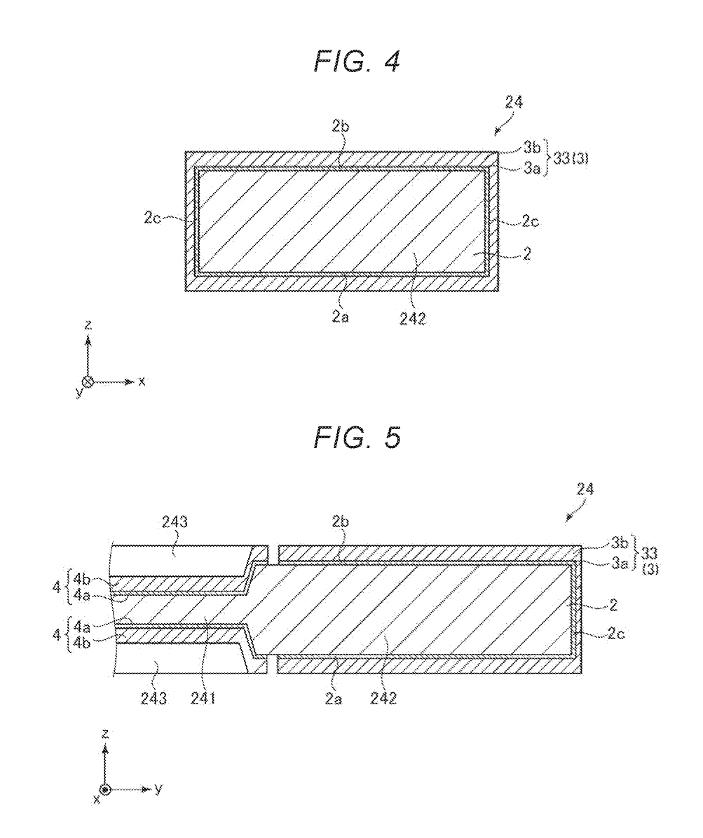

FIG. 1 is a plan view showing a vibrating element according to the first embodiment of the present disclosure. FIG. 2 is a cross-sectional view along the line A-A in FIG. 1. FIG. 3 is a plan view showing the neighborhood of a weight section of a vibrating arm (a drive arm) of the vibrating element in an enlarged manner. FIG. 4 is a cross-sectional view along the line B-B in FIG. 3. FIG. 5 is a cross-sectional view along the line C-C in FIG. 3. In each of the drawings, each section is illustrated with the scale size appropriately exaggerated as needed, and further, the scale ratio between the sections does not necessarily coincide with the actual scale ratio. The position, the orientation, the size and so on of each section described below each include the range of the manufacturing error and so on, for example, the error no larger than ±1%, and are not limited to the position, the orientation, the size and so on described in the present specification as long as the necessary function of the section can be realized.

It should be noted that the description will hereinafter be presented arbitrarily using an x axis, a y axis, and a z axis as three axes perpendicular to each other for the sake of convenience of explanation. Hereinafter, a direction parallel to the x axis is referred to as an “x-axis direction,” a direction parallel to the y axis is referred to as a “y-axis direction,” a direction parallel to the z axis is referred to as a “z-axis direction,” and in the drawing, the tip side of the arrow representing each of the x axis, the y axis and the z axis is defined as “+,” and the base end side thereof is defined as “−.” Further, +z-axis direction side is also referred to as “up side,”−z-axis direction side is also referred to as “down side,” +x-direction side is also referred to as “right side,” and −x-direction side is also referred to as “left side.” Further, viewing from the z-axis direction is referred to as “plan view.” In FIG. 1, illustration of electrode films 4 described later is omitted for the sake of convenience of explanation.

The vibrating element 1 shown in FIG. 1 is a sensor element for detecting the angular velocity around the Z axis. The vibrating element 1 has a vibrator element 2 (see FIG. 1), and the electrode films 4 (see FIG. 2) disposed on the vibrator element 2.

As shown in FIG. 1, the vibrator element 2 has a structure called a double T type as it called. In the specific description, the vibrator element 2 has a base 21, a pair of detection arms 22, 23, a pair of drive arms 24, 25 and a pair of drive arms 26, 27 all extending from the base 21. In other words, the vibrator element 2 has totally 6 vibrating arms extending from the base 21.

Here, the base 21 has a base main body 211 supported by a package 11 described later, a coupling arm 212 extending from the base main body 211 along the +x-axis direction, and a coupling arm 213 extending from the base main body 211 along the −x-axis direction which is an opposite direction to the extending direction of the coupling arm 212. Further, the detection arm 22 extends from the base main body 211 along the +y-axis direction crossing the extending direction of the coupling arms 212, 213, and the detection arm 23 extends from the base main body 211 along the −y-axis direction which is an opposite direction to the extending direction of the detection arm 22. The drive arm 24 extends from a tip area of the coupling arm 212 along the +y-axis direction, and the drive arm 25 extends from the tip area of the coupling arm 212 along the −y-axis direction which is an opposite direction to the extending direction of the drive arm 24. Similarly, the drive arm 26 extends from a tip area of the coupling arm 213 along the +y-axis direction, and the drive arm 27 extends from the tip area of the coupling arm 213 along the −y-axis direction which is an opposite direction to the extending direction of the drive arm 26.

Further, the detection arm 22 has an arm section 221 (a detection arm section) extending from the base main body 211, a weight section 222 (a detection weight section) which is disposed on the tip side with respect to the arm section 221 and which is larger in width than the arm section 221, and grooves 223 disposed respectively on the upper and lower surfaces of the arm section 221. Similarly, the detection arm 23 has an arm section 231 (a detection arm section), a weight section 232 (a detection weight section), and a pair of grooves 233.

Further, the drive arm 24 has an arm section 241 (a drive arm section) extending from the coupling arm 212, a weight section 242 (a drive weight section) which is disposed on the tip side with respect to the arm section 241 and which is larger in width than the arm section 241, and a pair of grooves 243 disposed respectively on the upper and lower surfaces of the arm section 241. Similarly, the drive arm 25 has an arm section 251 (a drive arm section), a weight section 252 (a drive weight section), and a pair of grooves 253. Further, the drive arm 26 has an arm section 261 (a drive arm section) extending from the coupling arm 213, a weight section 262 (a drive weight section) which is disposed on the tip side with respect to the arm section 261 and which is larger in width than the arm section 261, and a pair of grooves 263 disposed respectively on the upper and lower surfaces of the arm section 261. Similarly, the drive arm 27 has an arm section 271 (a drive arm section), a weight section 272 (a drive weight section), and a pair of grooves 273.

It should be noted that the arm sections 221, 231, 241, 251, 261 and 271 denote parts of the vibrating arm respectively provided with the grooves 223, 233, 243, 253, 263 and 273. On the other hand, the weight sections 222, 232, 242, 252, 262 and 272 denote other parts of the vibrating arm than the arm sections 221, 231, 241, 251, 261 and 271, respectively. Specifically, the weight sections 222, 232, 242, 252, 262 and 272 are concepts including parts larger in width than the arm sections 221, 231, 241, 251, 261 and 271, and parts between the tips (ends on the far side from the base 21) of the grooves 223, 233, 243, 253, 263 and 273 and the parts larger in width than the arm sections 221, 231, 241, 251, 261 and 271, respectively.

It should be noted that taking also the case in which the grooves 223, 233, 243, 253, 263 and 273 are not disposed into consideration, the weight sections 222, 232, 242, 252, 262 and 272 are concepts each including the part relatively larger in width, and a part of a range corresponding to 10% of the length of the vibrating arm, the part extending from the base end of the part larger in width toward the base 21.

Incidentally, for example, as the drive arm 24, it is possible to adopt a shape in which the length from the center in the y-axis direction of the coupling arm as the base to the tip of the weight section 242 is 1.00 mm, the length in the y-axis direction of the weight section is 0.33 mm, the size in the x-axis direction of the weight section is 0.26 mm, the size in the x-axis direction of the arm section 241 is 0.09 mm, and the thickness as the size in the z-axis direction is 0.10 mm, and as the detection arm 22, it is possible to adopt a shape in which the length from the center in the y-axis direction of the base main body 211 to the tip of the weight section 222 is 1.00 mm, the length in the y-axis direction of the weight section is 0.33 mm, the size in the x-axis direction of the weight section is 0.40 mm, the size in the x-axis direction of the arm section 221 is 0.08 mm, and the thickness is 0.10 mm.

It should be noted that at least either one of the vertical pair of each of the grooves 223, 233, 243, 253, 263 and 273 can be omitted. Further, it is also possible for the vertical pair of each of the grooves 223, 233, 243, 253, 263 and 273 to be communicated with each other. In other words, it is also possible to provide a through hole opening in the upper and lower surfaces to any of the arm sections 221, 231, 241, 251, 261 and 271. Further, the widths of the weight sections 222, 232, 242, 252, 262 and 272 can be equal to or smaller than the widths of the arm sections 221, 231, 241, 251, 261 and 271, respectively.

Here, the arm section 221 is a part bending when the detection arm 22 vibrates (performs a detection vibration), and at the same time, a part for detecting a charge generated with the detection vibration of the detection arm 22, namely a part provided with a detection signal electrode 43 and a detection ground electrode 44 described later. Similarly, the arm section 231 is a part bending when the detection arm 23 vibrates (performs the detection vibration), and at the same time, apart for detecting a charge generated with the detection vibration of the detection arm 23, namely a part provided with a detection signal electrode 45 and the detection ground electrode 44 described later. Further, the arm section 241 is a part bending when the drive arm 24 vibrates (performs a drive vibration), and at the same time, a part to which an electrical field for driving the drive arm 24 is applied, namely a part provided with a drive signal electrode 41 and a drive ground electrode 42 described later. Similarly, the arm sections 251, 261 and 271 are each a part bending when corresponding one of the drive arms 25, 26 and 27 vibrate (perform the drive vibration), and at the same time, a part to which an electrical field for driving corresponding one of the drive arms 25, 26 and 27 is applied, namely a part provided with the drive signal electrode 41 and the drive ground electrode 42 described later. Further, the weight section 222 is located on the tip side of the arm section 221. Similarly, the weight sections 232, 242, 252, 262 and 272 are respectively located on the tip side of the arm sections 231, 241, 251, 261 and 271.

The vibrator element 2 is formed of, for example, a Z-cut quartz crystal plate. By forming the vibrator element 2 with the Z-cut quartz crystal plate, it is possible to make the vibration characteristics, in particular the frequency-temperature characteristic of the vibrator element 2 excellent. Further, etching makes it possible to form the vibrator element 2 with high dimensional accuracy. The quartz crystal belongs to the trigonal system, and is provided with an X axis, a Y axis, and a Z axis perpendicular to each other as the crystal axes. The X axis, the Y axis, and the Z axis are called an electrical axis, a mechanical axis, and an optical axis, respectively. The Z-cut quartz crystal plate is a quartz crystal plate shaped like a plate having a spread in the X-Y plane defined by the Y axis (the mechanical axis) and the X axis (the electrical axis), and a thickness in the Z-axis (the optical axis) direction. Here, the X axis of the quartz crystal constituting the vibrator element 2 is parallel to the x axis, the Y axis is parallel to the y axis, and the Z axis is parallel to the z axis.

It should be noted that the vibrator element 2 can also be formed of a piezoelectric material other than quartz crystal. As the piezoelectric material other than quartz crystal, there can be cited, for example, lithium tantalate, lithium niobate, lithium borate, and barium titanate. Further, depending on the configuration of the vibrator element 2, the vibrator element 2 can be formed of a quartz crystal plate with a cut angle other than the Z cut. Further, the vibrator element 2 can also be formed of a material other than the piezoelectric material, namely a material not having a piezoelectric property such as silicon, and in this case, it is sufficient to dispose a piezoelectric element on each of the arm sections of the detection arms 22, 23 and the drive arms 24, 25, 26 and 27, wherein as an example the piezoelectric element is an element having a configuration in which a piezoelectric film formed of, for example, PZT is sandwiched between a pair of electrodes.

Among the obverse surfaces of the vibrator element 2 configured in such a manner, on the arm sections 221 and 231 of the detection arms 22 and 23, and on the arm sections 241, 251, 261 and 271 of the drive arms 24, 25, 26 and 27 (vibrating arm), there are disposed the electrode films 4. The electrode films 4 include the drive signal electrode 41, the drive ground electrode 42, the detection signal electrode 43 and the detection ground electrode 44 shown in FIG. 2, and the detection signal electrode 45 shown in FIG. 1.

The drive signal electrode 41 is an electrode for exciting the drive vibration of the drive arms 24, 25, 26 and 27. As shown in FIG. 2, the drive signal electrode 41 is disposed on each of the upper and lower surfaces of the arm section 241 out of a first principal surface 2a (the lower surface) and a second principal surface 2b (the upper surface) in an obverse-reverse relationship of the drive arm 24, and both side surfaces (both of the side surfaces each connecting the upper surface and the lower surface) of the arm section 261 of the drive arm 26. Similarly, the drive signal electrode 41 is disposed on each of the upper and lower surfaces (see FIG. 1) of the arm section 251 out of the first principal surface 2a (the lower surface) and the second principal surface 2b (the upper surface) in an obverse-reverse relationship of the drive arm 25, and both side surfaces (both of the side surfaces each connecting the upper surface and the lower surface) of the arm section 271 of the drive arm 27.

On the other hand, the drive ground electrode 42 has an electrical potential to be the reference with respect to the drive signal electrode 41 such as a ground potential. As shown in FIG. 2, the drive ground electrode 42 is disposed on each of the both side surfaces of the arm section 241, namely both of the side surfaces each connecting the upper surface and the lower surface, and the upper and lower surfaces of the arm section 261 of the drive arm 26. Similarly, the drive ground electrode 42 is disposed on each of the both side surfaces of the arm section 251, namely both of the side surfaces each connecting the upper surface and the lower surface, and the upper and lower surfaces (see FIG. 1) of the arm section 271 of the drive arm 27. In other words, the drive arms 24, 25, 26 and 27 are each provided with a pair of electrode films 4 which are respectively disposed on the upper surface and the lower surface, and which are electrically isolated from each other.

The detection signal electrode 43 is an electrode for detecting the charge generated by detection vibration of the detection arm 22 when the detection vibration of the detection arm 22 is excited. As shown in FIG. 2, the detection signal electrode 43 is disposed on the upper and lower surfaces of the arm section 221 out of the first principal surface 2a (the lower surface) and the second principal surface 2b (the upper surface) in the obverse-reverse relationship of the detection arm 22.

On the other hand, the detection ground electrode 44 has an electrical potential to be the reference with respect to the detection signal electrode 43 such as a ground potential. As shown in FIG. 2, the detection ground electrode 44 is disposed on the both side surfaces of the arm section 221, namely both of the side surfaces each connecting the upper surface and the lower surface.

Further, the detection signal electrode 45 is for detecting the charge generated by the detection vibration of the detection arm 23 when the detection vibration of the detection arm 23 is excited, and the detection signal electrode 45 is disposed (see FIG. 1) on the upper and lower surfaces of the arm section 231 out of the first principal surface 2a (the lower surface) and the second principal surface 2b (the upper surface) in the obverse-reverse relationship of the detection arm 23. Similarly, the detection ground electrode of the detection arm 23 has an electrical potential (e.g., the ground potential) to be the reference with respect to the detection signal electrode of the detection arm 23, and is disposed (not shown) on both of the side surfaces (both of the side surfaces each connecting the upper surface and the lower surface) of the arm section 231 of the detection arm 23. It should be noted that it is also possible to perform the vibration detection due to a differential signal between the detection signal electrode 43 of the detection arm 22 and the detection signal electrode 45 of the detection arm 23.

Further, among the obverse surfaces of the vibrator element 2, on the weight sections 222 and 232 of the detection arms 22 and 23, and on the weight sections 242, 252, 262 and 272 of the drive arms 24, 25, 26 and 27 (the vibrating arms), there is disposed a weight film 3. As shown in FIG. 1, the weight film 3 includes a weight film 31 disposed on the weight section 222, a weight film 32 disposed on the weight section 232, a weight film 33 disposed on the weight section 242, a weight film 34 disposed on the weight section 252, a weight film 35 disposed on the weight section 262, and a weight film 36 disposed on the weight section 272.

The weight films 31, 32 are films which can be used for adjusting the resonance frequencies of the detection arms 22, 23 by removing the weight films 31, 32 as much as an appropriate amount due to irradiation of an energy beam. Further, the weight films 33, 34, 35 and 36 are films which can be used for adjusting the resonance frequencies of the drive arms 24, 25, 26 and 27 by removing the weight films 33, 34, 35 and 36 as much as an appropriate amount due to irradiation of an energy beam.

As shown in FIG. 4, the weight film 33 is disposed on the upper and lower surfaces of the weight section 242 and the both side surfaces of the weight section 242 out of the first principal surface 2a (the lower surface) and the second principal surface 2b (the upper surface) in the obverse-reverse relationship of the drive arm 24. In other words, the weight film 33 is disposed so as to surround the weight section 242.

Therefore, out of the upper and lower surfaces of the drive arm 24, the drive signal electrode 41 is provided to the arm section 241, and the weight film 33 is provided to the weight section 242. Further, when viewing the drive arm 24 as a whole, the film as an integrated member is disposed from the arm section 241 to the weight section 242, wherein a part of the film disposed in the arm section 241 corresponds to the electrode film 4 (the drive signal electrode 41), and a part of the film disposed in the weight section 242 corresponds to the weight film 3 (the weight film 33).

Further, similarly to such a weight film 33, the weight films 34, 35 and 36 are disposed so as to surround the weight sections 252, 262 and 272, respectively. Further, when viewing each of the drive arms 25, 26 and 27 as a whole, the films as integrated members are disposed from the arm sections 251, 261 and 271 to the weight sections 252, 262 and 272, wherein parts of the films disposed on the arm sections 251, 261 and 271 correspond to the electrode films 4 (the drive signal electrodes 41 or the drive ground electrodes 42), and parts of the films disposed in the weight sections 252, 262 and 272 correspond to the weight film 3 (the weight films 34, 35 and 36), respectively.

Here, the thickness of the electrode film 4 and the thickness of the weight film 3 are each set in a range no smaller than 50 nm and no larger than 500 nm. By making the thickness of the electrode film 4 and the thickness of the weight film 3 fall within the range described above, it becomes possible to form the electrode film 4 and the weight film 3 in the same process. Therefore, it is possible to achieve the reduction of the manufacturing man-hour of the vibrating element 1, and it is possible to easily manufacture the vibrating element 1. Therefore, such a vibrating element 1 becomes high in manufacturing efficiency, and low in manufacturing cost.

Further, in particular, by making the thickness of the weight film 3 fall within the range described above, the weight film 3 becomes to have the thickness with which a sufficient mass change can occur when irradiated with the energy beam. Thus, it is possible to ensure the wide adjustable range of the frequency of the drive arms 24, 25, 26 and 27, and thus, it is possible to achieve reduction of the fraction defective. In addition, by appropriately suppressing the thickness, it is possible to prevent a damage or the like from occurring in the vibrating element 1 due to an increase in the film stress.

On the other hand, by making the thickness of the electrode film 4 fall within the range described above, the electrode film 4 becomes to have sufficient electrical conductivity. Thus, it is possible to achieve reduction of power consumption in the vibrating element 1. In addition, by appropriately suppressing the thickness, it is possible to prevent the vibration characteristics of the drive arms 24, 25, 26 and 27 such as time degradation of the mechanical characteristics from degrading.

It should be noted that if the thickness of the weight film 3 falls below the lower limit value described above, it is not possible to generate a sufficient mass change in the weight film 3 when irradiated with the energy beam, and therefore, there is a possibility that the adjustable range of the resonance frequencies of the drive arms 24, 25, 26 and 27 becomes narrow. In contrast, if the thickness of the weight film 3 exceeds the upper limit value, the film stress increases, and therefore, there is a possibility that a damage or the like occurs in the vibrating element 1.

Further, if the thickness of the electrode film 4 falls below the lower limit value described above, there is a possibility that the electrical conductivity of the electrode film 4 degrades. On the other hand, if the thickness of the electrode film 4 exceeds the upper limit value described above, there is a possibility that the film stress increases, and at the same time, the vibration characteristics of the drive arms 24, 25, 26 and 27 degrade to thereby degrade the detection characteristics in the vibrating element 1.

Further, as shown in FIG. 5, the electrode film 4 has a first film 4a located on a foundation side, namely the vibrator element 2 side, and a second film 4b located on the first film 4a, namely on an opposite side to the foundation side. By adopting such a multilayer structure, it is possible to form, for example, the first film 4a with a material high in adhesiveness with the foundation, and form the second film 4b with a material high in electrical conductivity. Thus, it is possible to realize the electrode film 4 high in adhesiveness with the foundation, and good in electrical conductivity.

Similarly, as shown in FIG. 4 and FIG. 5, the weight film 3 has a first film 3a located on a foundation side, namely the vibrator element 2 side, and a second film 3b located on the first film 3a, namely on an opposite side to the foundation side. By adopting such a multilayer structure, it is possible to form, for example, the first film 3a with a material high in adhesiveness with the foundation, and form the second film 3b with a material good in workability by the energy beam.

Thus, it is possible to realize the weight film 3 which is high in adhesiveness with the foundation, and which makes it easy to adjust the frequencies of the drive arms 24, 25, 26 and 27.

As the constituent material of the first films 4a, 3a, there can be cited a simple body or an alloy of a metal material such as titanium (Ti) or chromium (Cr), or a material including these materials. Thus, it is possible to realize the first films 4a, 3a superior in adhesiveness with the vibrator element 2 formed using, for example, quartz crystal.

As the constituent material of the second films 4b, 3b, there can be used a metal material such as gold (Au), gold alloy, platinum (Pt), aluminum (Al), aluminum alloy, silver (Ag), silver alloy, chromium (Cr), chromium alloy, copper (Cu), molybdenum (Mo), niobium (Nb), tungsten (W), iron (Fe), titanium (Ti), cobalt (Co), zinc (Zn), or zirconium (Zr), or a transparent electrode material such as ITO or ZnO, and above all, it is preferable to use metal including gold as a chief material such as gold or a gold alloy, or to use platinum.

Further, in particular, as the constituent material of the weigh film 3, it is possible to use, for example, an inorganic compound or resin in addition to the materials described above.

Among these, as the inorganic compound, there can be cited oxide ceramics such as alumina (aluminum oxide), silica (silicon dioxide), titania (titanium oxide), zirconia, yttria, or calcium phosphate, nitride ceramics such as silicon nitride, aluminum nitride, titanium nitride, or boron nitride, carbide ceramics such as graphite or tungsten carbide, or other ferroelectric materials such as barium titanate, strontium titanate, PZT, PLZT, or PEBZT, and above all, it is preferable to use an insulating material such as silicon oxide (SiO₂), titanium oxide (TiO₂) or aluminum oxide (Al₂O₃).

It should be noted that it is preferable for the first films 4a, 3a to include in particular chromium (Cr), and it is preferable for the second films 4b, 3b to include in particular gold (Au). Thus, it is possible to satisfy both of the adhesiveness with the foundation, and the electrical conductivity and the workability.

The vibrating element 1 configured in such a manner detects the angular velocity ω around the z axis in the following manner. Firstly, by applying a voltage (a drive signal) between the drive signal electrode 41 and the drive ground electrode 42, the drive arm 24 and the drive arm 26 are made to perform a flexural vibration (a drive vibration) so as to repeat getting closer to and getting away from each other in a direction indicated by the arrow a in FIG. 1, and at the same time, the drive arm 25 and the drive arm 27 are made to perform a flexural vibration (a drive vibration) so as to repeat getting closer to and getting away from each other in the same direction as that of the flexural vibration described above. On this occasion, if no angular velocity is applied to the vibrating element 1, the base main body 211, the coupling arms 212, 213, and the detection arms 22, 23 hardly vibrate since the drive arms 24, 25 and the drive arms 26, 27 perform a plane-symmetrical vibration about the y-z plane passing through the centroid G.

In the state (a drive mode) in which the drive arms 24 through 27 are made to perform the drive vibration as described above, when the angular velocity ω around the normal line passing through the centroid G, namely around the z axis, is applied to the vibrating element 1, the Coriolis force acts on each of the drive arms 24 through 27. Thus, the coupling arms 212, 213 perform the flexural vibrations in the direction indicated by the arrow b in FIG. 1, and accordingly, the flexural vibrations (the detection vibrations) in the direction indicated by the arrows c in FIG. 1 of the detection arms 22, 23 are excited so as to cancel the flexural vibrations of the coupling arms 212, 213. Further, due to such detection vibrations (the detection mode) of the detection arms 22, 23, the charge is generated between the detection signal electrode 43 and the detection ground electrode 44. The angular velocity ω applied to the vibrating element 1 can be obtained based on such a charge.

As described hereinabove, the vibrating element 1 is provided with the base 21, the drive arms 24, 25, 26 and 27 (the vibrating arms) extending from the base 21 and having the arm sections 241, 251, 261 and 271 located on the base 21 side and the weight sections 242, 252,262 and 272 located on the tip side of the arm sections 241, 251, 261 and 271, the electrode films 4 disposed on the arm sections 241, 251, 261 and 271, and the weight film 3 disposed on the weight sections 242, 252, 262 and 272. Further, the thickness of the electrode film 4 and the thickness of the weight film 3 are each set in a range no smaller than 50 nm and no larger than 500 nm.

According to such a vibrating element 1, it becomes possible to form the electrode films 4 and the weight film 3 in the same process. Therefore, it is possible to achieve the reduction of the manufacturing man-hour of the vibrating element 1, and it is possible to easily manufacture the vibrating element 1. Further, it is possible to ensure the sufficiently wide adjustable range of the frequency without degrading the vibration characteristics of the drive arms 24, 25, 26 and 27, and thus, it is possible to achieve reduction of the fraction defective.

On the other hand, although it is not necessary for the thickness of the weight film 3 described above to be within the range described above in the entire area of the weight sections 242, 252, 262 and 272 in the plan view, it is preferable for the thickness of the part equal to or larger than 50% of the total area of the weight film 3 to be within the range described above, and it is more preferable for the thickness of the part equal to or larger than 70% to be within the range described above taking the production tolerance into consideration.

It should be noted that the thickness of the electrode film 4 and the thickness of the weight film 3 are each made no smaller than 50 nm and no larger than 500 nm, but are preferably no smaller than 100 nm and no larger than 400 nm, and are more preferably no smaller than 200 nm and no larger than 300 nm.

Further, the thickness of the electrode film 4 and the thickness of the weight film 3 can be equal to each other or can also be different from each other as long as the thicknesses are within the range described above. In the case in which the thicknesses are equal to each other, since it is not necessary to control the thickness when forming the films, it is possible to more easily form the electrode films 4 and the weight film 3. It should be noted that the state in which the thicknesses are equal to each other denotes the state in which the difference between the thicknesses is equal to or smaller than 30 nm. On the other hand, in the case in which the thicknesses are different from each other, for example, in the case of making the weight film 3 thicker in thickness than the electrode films 4, it is possible to make the total mass of the weight sections 242, 252, 262 and 272 and the weight film 3 more than the total mass of the arm sections 241, 251, 261 and 271 and the electrode films 4. Therefore, it is possible to, for example, improve the vibration characteristics of the vibrating element 1, such as the detection sensitivity, and shorten the length of the drive arms 24, 25, 26 and 27 to thereby achieve reduction in size of the vibrating element 1.

Further, the thickness of the electrode film 4 described above is not required to be within the range described above in the entire area of the arm sections 241, 251, 261 and 271 in the plan view, and it is preferable that the thickness of the electrode film 4 in at least the tip portions of the arm sections 241, 251, 261 and 271, namely in at least the areas continuous to the weight sections 242, 252, 262 and 272 out of the arm sections 241, 251, 261 and 271, is the same as the thickness of the weight film 3. Thus, it is possible to easily form the electrode films 4 and the weight film 3 in the same process without regard to the boundary between the electrode films 4 and the weight film 3.

It should be noted that the tip portions of the arm sections 241, 251, 261 and 271 denote the ranges starting from the base ends of the weight sections 242, 252, 262 and 272 toward the base 21 and corresponding to 10% of the lengths of the arm sections 241, 251, 261 and 271, respectively.

Further, the thicknesses of the first film 4a and the first film 3a as the foundation films are each preferably no smaller than 5 nm and no larger than 50 nm, and more preferably no smaller than 10 nm and no larger than 40 nm. Thus, the function as the foundation film, namely an improvement of adhesiveness, is ensured, and at the same time, the foundation film is prevented from becoming too thick, and thus, it is possible to prevent the functions of the second film 4b and the second film 3b, for example, the electrical conductivity and the mass adjustment function from being hindered.

It should be noted that the thickness of the electrode films 4 and the thickness of the weight film 3 provided to the detection arms 22, 23 can be within the range from 50 nm to 500 nm described above, or can also be out of the range described above. If the thicknesses are within the range described above, it becomes possible to form the electrode films 4 and the weight film 3 provided to the detection arms 22, 23 in the same process as the electrode films 4 and the weight film 3 provided to the drive arms 24, 25, 26 and 27.

Further, it is also possible for the electrode films 4 and the weight film 3 to be disposed only on either one of the upper and lower surfaces. Even in such a case, it is possible to obtain the advantage that the electrode films 4 and the weight film 3 can be formed in the same process.

Further, in the case in which the drive arms 24, 25, 26 and 27 each have the first principal surface 2a (the lower surface) and the second principal surface 2b (the upper surface) in the obverse-reverse relationship as described above, it is preferable for the electrode films 4 to be disposed on both of the lower surface and the upper surface. Further, in this case, the thickness of the electrode film 4 disposed on the lower surface is not particularly limited, but is preferably no less than 50% and no more than 200% of the thickness of the electrode film 4 disposed on the upper surface, and further preferably no less than 75% and no more than 150% thereof. Thus, since the electrode films 4 disposed on the upper and lower surfaces become comparable in thickness to each other, it becomes easy to approximate the mass balance between the upper surface side and the lower surface side to a balanced state. In other words, it is possible to approximate the centroid of the structure constituted by the electrode films 4 and the arm sections 241, 251, 261 and 271 provided with the electrode films 4 to the central plane of the thickness of the arm sections 241, 251, 261 and 271. Thus, when vibrating each of the pair of the drive arm 24 and the drive arm 26 and the pair of the drive arm 25 and the drive arm 27 in the direction of getting closer to or away from each other, namely vibrating each of the pairs in an in-plane direction, it is possible to prevent the vibration including the directional component of the thickness direction, namely an out-of-plane direction, from occurring in the drive arms 24, 25, 26 and 27. Therefore, it is possible to prevent such a vibration component in the thickness direction from being leaked via the base 21 to the outside of the vibrating element 1 to cause a noise vibration for the outside of the vibrating element 1.

Further, in the case in which the drive arms 24, 25, 26 and 27 each have the first principal surface 2a (the lower surface) and the second principal surface 2b (the upper surface) in the obverse-reverse relationship as described above, it is preferable for the weight film 3 to be disposed on both of the lower surface and the upper surface. Further, in this case, the thickness of the weight film 3 disposed on the lower surface is not particularly limited, but is preferably no less than 50% and no more than 200% of the thickness of the weight film 3 disposed on the upper surface, and further preferably no less than 75% and no more than 150% thereof. Thus, since the weight film 3 disposed on the upper surface and the weight film 3 disposed on the lower surface become comparable in thickness to each other, it becomes easy to approximate the mass balance between the upper surface side and the lower surface side to a balanced state even after partially removing the weight film 3 to adjust the frequency. In other words, it is possible to approximate the centroid of the structure constituted by the weight film 3 and the weight sections 242, 252, 262 and 272 provided with the weight film 3 to the central plane of the thickness of the weight sections 242, 252, 262 and 272. Thus, when vibrating each of the pair of the drive arm 24 and the drive arm 26 and the pair of the drive arm 25 and the drive arm 27 in the direction of getting closer to or away from each other, namely vibrating each of the pairs in an in-plane direction, it is possible to prevent the vibration including the directional component of the thickness direction, namely an out-of-plane direction, from occurring in the drive arms 24, 25, 26 and 27. Therefore, it is possible to prevent such a vibration component in the thickness direction from being leaked via the base 21 to the outside of the vibrating element 1 to cause a noise vibration for the outside of the vibrating element 1.

On the other hand, in the case in which the drive arms 24, 25, 26 and 27 each have the side surface 2c (see FIG. 4 and FIG. 5) for connecting the first principal surface 2a (the lower surface) and the second principal surface 2b (the upper surface) to each other, it is preferable for the weight film 3 to be disposed also on the side surface 2c. Thus, the weight film 3 is also deposited on the side surface 2c in addition to the upper and lower surfaces, and therefore, time and effort for preventing the deposition to the side surface 2c become unnecessary. Therefore, it is possible to achieve further reduction of the manufacturing man-hour of the vibrator element 2.

Further, the thickness of the weight film 3 disposed on the side surface 2c is not particularly limited, but is preferably no less than 50% and no more than 200% of the thickness of the weight film 3 disposed on the upper surface, and further preferably no less than 75% and no more than 150% thereof. Thus, the electrode films 4 disposed on the upper and lower surfaces become comparable in thickness to each other, and therefore, it becomes easier to form the weight film 3.

It should be noted that it is also possible to dispose the electrode films 4 on the side surface 2c.

Further, the positions, the sizes, the ranges and so on of the weight films 31 through 36 are not limited to the positions, the sizes, the ranges and so on shown in the drawings. For example, the weight film 3 can be disposed on the entire areas in the length direction (the y-axis direction) of the weight sections 222, 232, 242, 252, 262 and 272, but can also be partially disposed. Similarly, the weight film 3 can be disposed on the entire areas in the width direction (the x-axis direction) of the weight sections 222, 232, 242, 252, 262 and 272, but can also be partially disposed.

Further, it is preferable for each of the arm sections 241, 251, 261 and 271 to have a plane-symmetrical shape about the central plane in the thickness direction. Thus, it is possible to reduce the vibration in the thickness direction due to the shapes of the drive arms 24, 25, 26 and 27.

As shown in FIG. 3, it is preferable for the width W of the weight sections 242, 252, 262, 272 to be larger than the width W0 of the arm section 241, 251, 261, 271 in the plan view from the thickness direction of the weight section 242. Thus, it is possible to increase the area of the weight sections 242, 252, 262, 272 to which the weight films 33, 34, 35, 36 are provided. Further, it is possible to shorten the length of the drive arms 24, 25, 26, 27, and as a result, it is also possible to achieve reduction in size of the vibrating element 1.

Further, the electrode film 4 and the weight film 3 are uniform in thickness in FIG. 4 and FIG. 5, but can have a plurality of portions different in thickness from each other within the range described above. In other words, it is possible for the weight film 3 to have a relatively thick portion and a relatively thin portion. In this case, it is possible to irradiate a part of the weight film 3 with the energy beam to remove the part to thereby easily perform a fine adjustment and a coarse adjustment when performing the adjustment of the resonance frequency of the drive arms 24, 25, 26, 27. Specifically, the portion thick in thickness is large in mass per unit area, and is suitable for the coarse adjustment of the resonance frequency of the drive arms 24, 25, 26, 27. In contrast, the portion thin in thickness is small in mass per unit area, and is suitable for the fine adjustment of the resonance frequency of the drive arms 24, 25, 26, 27.

### Method of Manufacturing Vibrating Element

Then, a method of manufacturing the vibrating element according to the first embodiment will be described using the case of manufacturing the vibrating element 1 described above as an example. It should be noted that although one of the drive arms will hereinafter be described as a representative, the same applies to the other of the drive arms and the detection arms.

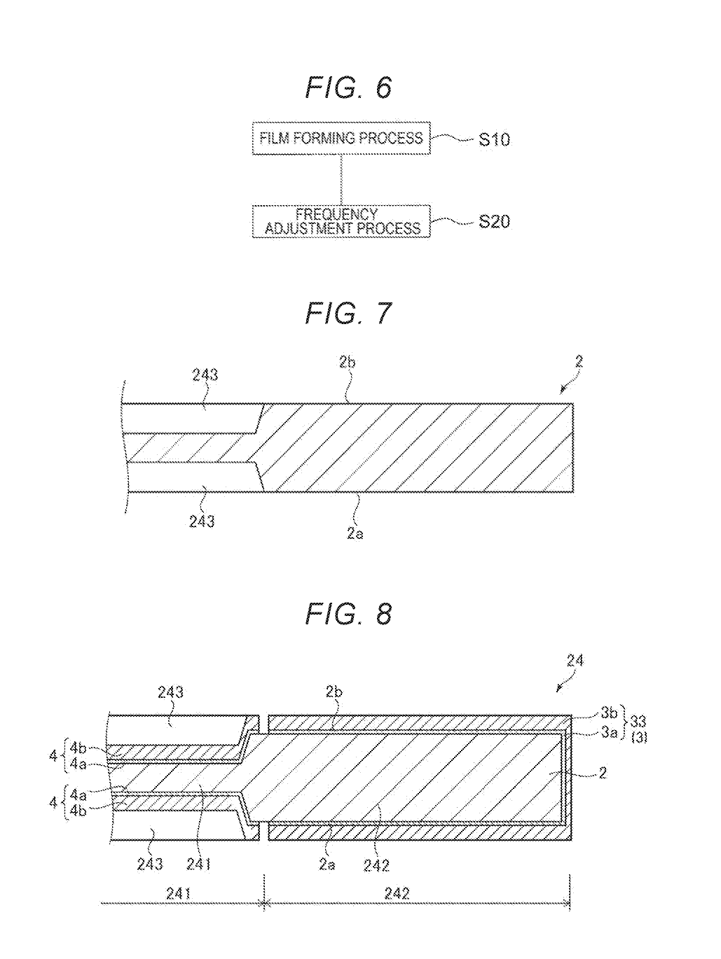

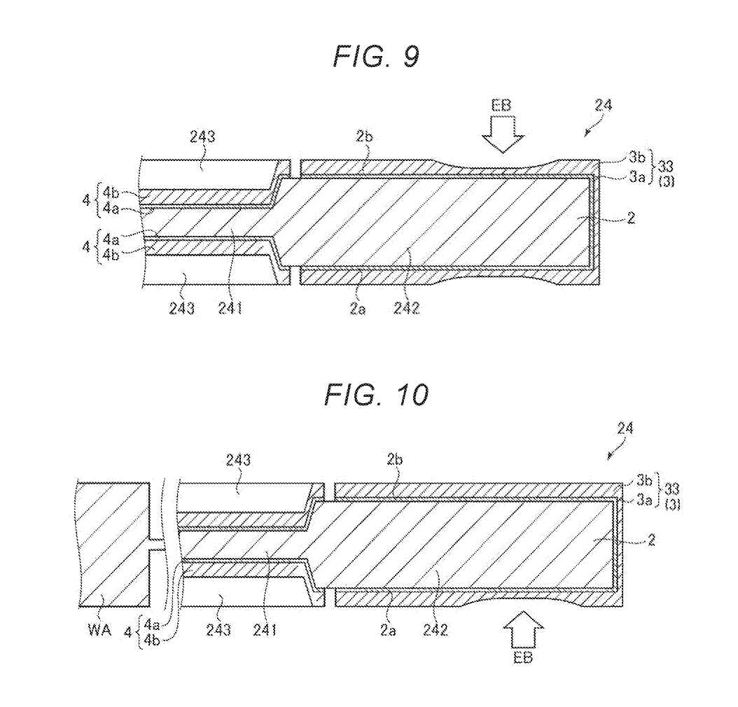

FIG. 6 is a flowchart showing the method of manufacturing the vibrating element according to the first embodiment. FIG. 7 and FIG. 8 are each a cross-sectional view for explaining the film forming process of forming the electrode films and the weight film on the vibrating arm in the method of manufacturing the vibrating element according to the first embodiment. FIG. 9 is a cross-sectional view for explaining a frequency adjustment process in the method of manufacturing the vibrating element according to the first embodiment.

As shown in FIG. 6, the method of manufacturing the vibrating element 1 has a film forming process S10 and a frequency adjustment process S20. Hereinafter, each of the processes will sequentially be described.

### Film Forming Process S10

Firstly, the vibrator element 2 shown in FIG. 7 is prepared.

The vibrator element 2 is manufactured by performing patterning on a base material such as a quartz crystal substrate, for example, a quartz crystal wafer, using a photolithography technique, an etching technique and so on to thereby carve out a target plan view shape. Further, the groove 243 and so on can also be formed together with the target plan view shape.

It should be noted that it is also possible to arrange to manufacture the plurality of vibrator elements 2 at the same time from the wafer. On that occasion, the vibrator elements 2 can also be manufactured in the state in which the vibrator elements 2 are not completely separated from the wafer, but are coupled to the wafer via breaking-off parts formed to be small in, for example, at least one of the width and the thickness, and therefore weak. Thus, it is possible to treat the plurality of vibrator elements 2 in a lump in the process described later to thereby enhance the manufacturing efficiency.

Subsequently, as shown in FIG. 8, among the first principal surface 2a (the lower surface) and the second principal surface 2b (the upper surface) of the drive arm 24, the electrode film 4 is formed on the arm section 241, and at the same time, the weight film 3 is formed on the weight section 242. On the drive arms 25, 26 and 27 other than the drive arm 24, and the detection arms 22, 23, the electrode films 4 and the weight film 3 are formed in a similar manner.

The electrode films 4 and the weight film 3 are each formed by uniformly forming a metal film using, for example, a sputtering process, and then patterning the metal film into a predetermined shape using a photolithography technique and the etching technique.

Here, the thickness of the electrode film 4 and the thickness of the weight film 3 are each set in a range no smaller than 50 nm and no larger than 500 nm as described above. By making the thickness of the electrode film 4 and the thickness of the weight film 3 fall within the range described above, it becomes possible to form the electrode film 4 and the weight film 3 at the same time in the same process using, for example, a sputtering process. Therefore, it is possible to achieve the reduction of the manufacturing man-hour of the vibrating element 1, and it is possible to easily manufacture the vibrating element 1. Therefore, it is possible to efficiently manufacture the vibrating element 1 at low cost.

Further, in the vapor-phase deposition process such as a sputtering process, the film is relatively isotropically formed, and therefore, it is difficult to cause a difference in film thickness of the metal film thus formed between the first principal surface 2a (the lower surface) and the second principal surface 2b (the upper surface) of the drive arm 24. Therefore, there is an advantage that it is possible to easily make the thicknesses of the electrode film 4 and the weight film 3 disposed on the upper surface and the lower surface approximate to each other, and thus it is easy to approximate the mass balance between the upper surface side and the lower surface side to the balanced state.

### Frequency Adjustment Process S20

Subsequently, as shown in FIG. 9, a part of the weight film 3 is removed by the energy beam EB. More specifically, the weight films 33 through 36 are each partially removed to thereby adjust the frequency of the drive vibration, namely the resonance frequencies of the drive arms 24 through 27 so that the resonance frequencies of the drive arms 24 through 27 become equal to each other. It should be noted that it is also possible to remove a part of the electrode film 4 instead of, or in addition to the removal of the weight film 3. Further, it is also possible to remove a part of the vibrator element 2 by irradiating a part not provided with the weight film 3 or the electrode film 4, namely the obverse surface of the vibrator element 2, with the energy beam EB to thereby adjust the frequency.

Further, as the need arises, the weight films 31, are partially removed to adjust the frequency of the detection vibration, namely the resonance frequencies of the detection arms 22, 23.

It should be noted that it is sufficient to perform these processes such as the irradiation process of the energy beam when needed, and if the adjustment of the frequency is unnecessary, these processes can be omitted.

Further, by making the thickness of the electrode film 4 and the thickness of the weight film 3 fall within the range described above, the weight film 3 becomes to have the thickness with which a sufficient mass change can occur when irradiated with the energy beam EB. Thus, it is possible to ensure the wide adjustable range of each of the frequencies of the detection arms 22, 23 and the drive arms 24, 25, 26 and 27 to thereby achieve reduction of the fraction defective.

As the energy beam EB, it is possible to use, for example, a pulse laser such as YAG, YVO₄, or an excimer laser, a continuous oscillation laser such as a carbon dioxide laser, a focused ion beam (FIB) and ion beam figuring (IBF).

Further, such a frequency adjustment process S20 can be performed on the wafer, or can also be performed in the state in which the vibrator element 2 is installed in the package 11 described later. Further, it is also possible to perform the frequency adjustment process S20 in multiple steps. For example, the coarse adjustment is performed as a first adjustment on the wafer, and then the fine adjustment is performed as a second adjustment in the state in which the vibrator element 2 is installed in the package 11.

As described above, the method of manufacturing the vibrating element 1 has the process of forming the base 21, the drive arm 24 (the vibrating arm) extending from the base 21 and having the arm section 241 located on the base 21 side and the weight section 242 located on the tip side of the arm section 241, the electrode films 4 disposed on the arm section 241 and having the thickness no smaller than 50 nm and no larger than 500 nm, and the weight film 3 located on the weight section 242 and having the thickness no smaller than 50 nm and no larger than 500 nm, and the process of adjusting the resonance frequency of the drive arm 24 by performing the irradiation with the energy beam EB to thereby remove at least one of a part of the weight film 3 and a part of the electrode film 4.

According to such a method of manufacturing the vibrating element 1, it becomes possible to form the electrode films 4 and the weight film 3 in the same process at the same time. Therefore, it is possible to achieve the reduction of the manufacturing man-hour of the vibrating element 1, and it is possible to easily manufacture the vibrating element 1. Therefore, it is possible to efficiently manufacture the vibrating element 1 at low cost.

Further, as described above, the drive arm 24 has the first principal surface 2a (the lower surface) and the second principal surface 2b (the upper surface) in the obverse-reverse relationship, and the electrode films 4 and the weight film 3 are each disposed on both of the upper surface and the lower surface. Further, the drive signal electrode 41 and the drive ground electrode 42 are isolated from each other. Further, it is preferable for the process of adjusting the resonance frequency of the drive arm 24 to be a process of removing at least one of a part of the electrode film 4 and a part of the weight film 3 disposed on the lower surface, and at the same time, removing at least one of apart of the electrode film 4 and a part of the weight film 3 disposed on the upper surface. In other words, it is preferable for the present process to be a process of partially removing the electrode films 4 or the weight film 3 on both of the lower surface side and the upper surface side.

By performing such a process, it becomes easy to approximate the mass balance between the upper surface side and the lower surface side to the balanced state. In other words, it is possible to approximate the centroid of the structure constituted by the electrode films 4 and the arm sections 241, 251, 261 and 271 provided with the electrode films 4 to the central plane of the thickness of the arm sections 241, 251, 261 and 271. Further, it is possible to approximate the centroid of the structure constituted by the weight film 3 and the weight sections 242, 252, 262 and 272 provided with the weight film 3 to the central plane of the thickness of the weight sections 242, 252, 262 and 272. Thus, when vibrating each of the pair of the drive arm 24 and the drive arm 26 and the pair of the drive arm 25 and the drive arm 27 in the direction of getting closer to or away from each other, namely vibrating each of the pairs in an in-plane direction, it is possible to prevent the vibration including the directional component of the thickness direction, namely an out-of-plane direction, from occurring in the drive arms 24, 25, 26 and 27. Therefore, it is possible to prevent such a vibration component in the thickness direction from being leaked via the base 21 to the outside of the vibrating element 1 to generate the noise vibration for the outside of the vibrating element 1.

It should be noted that in the case of partially removing the electrode films 4 or the weight film 3 on both of the lower surface side and the upper surface side in the present process, the laser is particularly preferably used as the energy beam EB. Due to the laser, it is possible to remove the electrode films 4 or the weight film 3 at the same time on both of the lower surface side and the upper surface side of the region irradiated with the laser. Therefore, it is possible to make the mass removed on the lower surface side and the mass removed on the upper surface side comparable to each other, and as a result, it becomes easier to approximate the mass balance between the lower surface side and the upper surface side to the balanced state. Therefore, it is possible to easily prevent the vibration including the directional component of the out-of-plane direction from occurring in the drive arms 24, 25, 26 and 27.

It should be noted that in the related-art vibrating element, the weight film is disposed only on either one of the lower surface and the upper surface in some cases. In such cases, since the mass imbalance between the lower surface side and the upper surface side has originally existed, if such a vibrating element is irradiated with the laser, roughly the same mass reduction occurs on both of the lower surface side and the upper surface side, and therefore, the mass imbalance having existed before the irradiation becomes worse as a result.

In contrast, according to the present embodiment, since the mass balance is in good condition before the irradiation as described above, by removing roughly the same mass on both of the lower surface side and the upper surface side by the irradiation of the laser, the mass balance is continuously kept in good condition after the irradiation. As a result, the mass balance between the lower surface side and the upper surface side is in good condition regardless of the presence or absence of the irradiation with the energy beam EB, and it is possible to effectively prevent the vibration including the directional component of the out-of-plane direction from occurring.

### Modified Examples

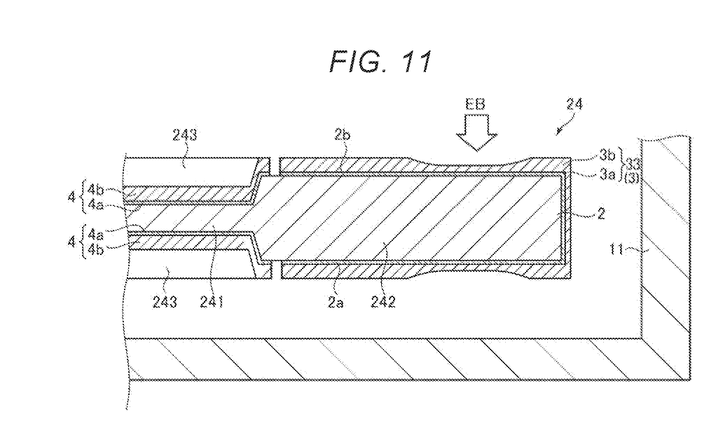

FIG. 10 and FIG. 11 are each a cross-sectional view for explaining the frequency adjustment process in the example in which the method of manufacturing the vibrating element according to the first embodiment is partially changed.

The modified example will hereinafter be described focusing mainly on the differences from the first embodiment described above, and the description of substantially the same matters will be omitted. It should be noted that in FIG. 10 and FIG. 11, the constituents substantially identical to those of the embodiment described above are denoted by the same reference symbols. Further, although one of the drive arms will hereinafter be described as a representative, the same applies to the other of the drive arms and the detection arms.

The present modified example is substantially the same as the first embodiment except that the frequency adjustment process is different. Specifically, in the first embodiment described above, a part of the weight film 3 or a part of the electrode films 4 is removed on both of the lower surface side and the upper surface side of the drive arm 24 of the vibrator element 2 at the sane time. In contrast, in the present modified example, a part of the weight film 3 or apart of the electrode films 4 disposed on the first principal surface 2a (the lower surface) of the drive arm 24 is removed, and then the vibrator element 2 is installed in the package 11 to remove apart of the weight film 3 or apart of the electrode films 4 disposed on the second principal surface 2b (the upper surface) of the drive arm 24.

Specifically, as shown in FIG. 10, the drive arm 24 has the first principal surface 2a (the lower surface) and the second principal surface 2b (the upper surface) in the obverse-reverse relationship, and the electrode films 4 and the weight film 3 are each disposed on both of the upper surface and the lower surface. Further, in the process of adjusting the resonance frequency of the drive arm 24, as shown in FIG. 10, at least one of a part of the electrode films 4 and a part of the weight film 3, namely a part of the weight film 3 in FIG. 10, disposed on the lower surface of the drive arm 24 is firstly removed in the state in which the vibrator element 2 is not yet installed in the package 11, for example, in a wafer state (the state in which the vibrator element 2 is coupled to a margin of a wafer WA). The removal amount on this occasion is appropriately set taking the balance with the removal amount on the upper surface side into consideration. In other words, the removal amount on the lower surface side is determined so as to be comparable to the removal amount on the upper surface side for the last time. In other words, it is sufficient to arrange to assign roughly a half of all of the necessary removal amount to the lower surface side, and assign the remaining roughly half to the upper surface side. Thus, it is possible to approximate the mass balance between the upper surface side and the lower surface side to the balanced state.

Further, in the wafer state, since it is possible to perform the process continuously on the plurality of vibrator elements 2, it is possible to improve the processing efficiency. Further, in the case of using an ion beam as the energy beam EB, it is possible to process only either one of the upper surface side and the lower surface side. Therefore, in the present modified example, since the lower surface side and the upper surface side are processed in sequence, the ion beam can also preferably be used. Due to the ion beam, since it is possible to more accurately control the removal amount per unit time, it is possible to more precisely adjust the frequency of the drive arm 24.

Subsequently, the vibrator element 2 including the drive arm 24 (the vibrating arm) is broken off from the margin of the wafer WA to install the vibrator element 2 to the package 11 as shown in FIG. 11.

Then, in the state in which the vibrator element 2 is installed in the package 11, at least one of a part of the electrode films 4 and a part of the weight film 3 disposed on the drive arm 24, namely a part of the weight film 3 in FIG. 11, is removed (see FIG. 11). Thus, it is possible to manufacture the vibrating element 1 in which the mass balance between the upper surface side and the lower surface side is in the balanced state. Further, in the state in which the package 11 is installed, only the upper surface side of the drive arm 24 can be irradiated with the ion beam. However, according to the present modified example, since the lower surface side is processed in advance, it is possible to perform the precise mass adjustment due to the ion beam without been affected by such a restriction.

### Second Embodiment

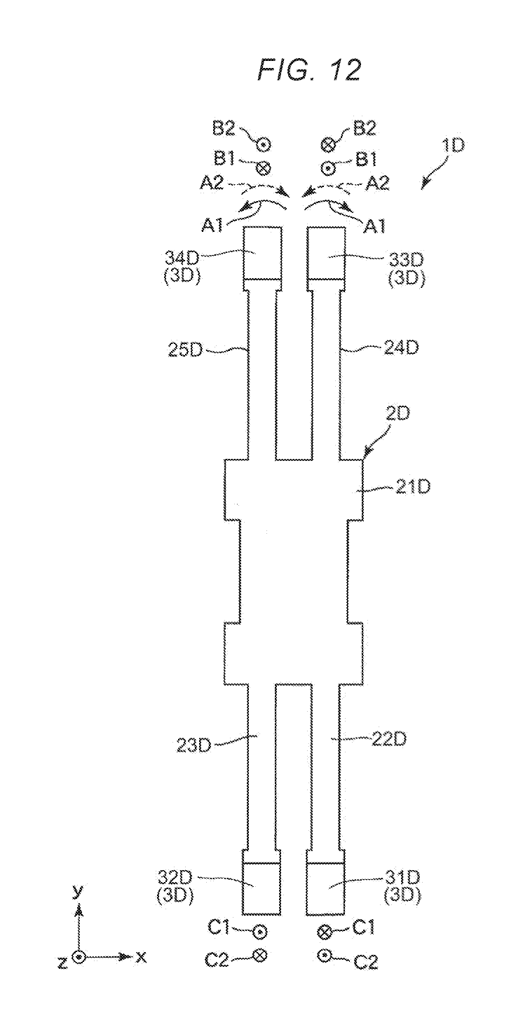

FIG. 12 is a plan view showing a vibrating element according to a second embodiment of the present disclosure.

The second embodiment will hereinafter be described focusing mainly on the differences from the embodiment described above, and the description of substantially the same matters will be omitted. It should be noted that in FIG. 12, the constituents substantially identical to those of the embodiment described above are denoted by the same reference symbols.

The present embodiment is substantially the same as the first embodiment described above except that the present disclosure is applied to a so-called H-type vibrating element.

The vibrating element 1D shown in FIG. 12 is a sensor element for detecting the angular velocity around the y axis. The vibrating element 1D is provided with a vibrator element 2D, and the electrode films (not shown) and a weight film 3D disposed on the vibrator element 2D.

The vibrator element 2D has a base 21D, a pair of drive arms 24D, 25D, and a pair of detection arms 22D, 23D. These constituents are configured as a unit, and is formed using a Z-cut quartz crystal plate. It should be noted that the correspondence relationship between the crystal axes of the quartz crystal and the x axis, the y axis and the z axis is substantially the same as in the first embodiment described above.

The base 21D is supported by the package 11 described later. The drive arms 24D, 25D each extend from the base 21D in the y-axis direction (the +y direction). The drive arms 24D, 25D are configured similarly to the drive arms in the first embodiment described above. Although not shown in the drawing, the drive arms 24D, 25D are each provided with a pair of drive electrodes (the drive signal electrode and the drive ground electrode) for flexurally vibrating the drive arms 24D, 25D in the x-axis direction due to the energization similarly to the drive arms 24 through 27 in the first embodiment described above. The pair of drive electrodes are electrically connected to terminals (not shown) on the base 21D via interconnections not shown.

The detection arms 22D, 23D each extend from the base 21D in the y-axis direction (the −y direction). Although not shown in the drawing, the detection arms 22D, 23D are each provided with a pair of detection electrodes for detecting a charge generated in accordance with the flexural vibration in the z-axis direction of the detection arms 22D, 23D, namely the detection signal electrode and the detection ground electrode. The pair of detection electrodes are electrically connected to terminals (not shown) on the base 21D via interconnections not shown.

The weight film 3D has weight films 31D, 32D respectively disposed on the tip portions (the weight sections) of the detection arms 22D, 23D, and weight films 33D, 34D respectively disposed on the tip portions (the weight sections) of the drive arms 24D, 25D.

In the vibrating element 1D configured in such a manner, by applying the drive signal between the pair of drive electrodes, the drive arm 24D and the drive arm 25D flexurally vibrate (make the drive vibration) so as to repeat getting closer to and away from each other as indicated by the arrows A1, A2 in FIG. 12.

When the angular velocity ω around the y axis is applied to the vibrating element 1D in the state in which the drive arms 24D, 25D are kept making the drive vibration in such a manner, the drive arms 24D, 25D flexurally vibrate to the respective side opposite to each other in the z-axis direction as indicated by the arrow B1, B2 in FIG. 12 due to the Coriolis force. In accordance therewith, the detection arms 22D, 23D flexurally vibrate (make the detection vibration) to the respective side opposite to each other in the z-axis direction as indicated by the arrows C1, C2 in FIG. 12.

Then, the charge generated between the pair of detection electrodes due to such a flexural vibration of the detection arms 22D, 23D is output from the pair of detection electrodes. The angular velocity ω applied to the vibrating element 1D can be obtained based on such a charge.

According also to such a present embodiment described hereinabove, it becomes possible to form the electrode films (not shown) and the weight film 3D in the same process similarly to the first embodiment described above, it is possible to achieve reduction of the manufacturing man-hour of the vibrating element 1D, and thus, it is possible to easily manufacture the vibrating element 1D.

### Third Embodiment

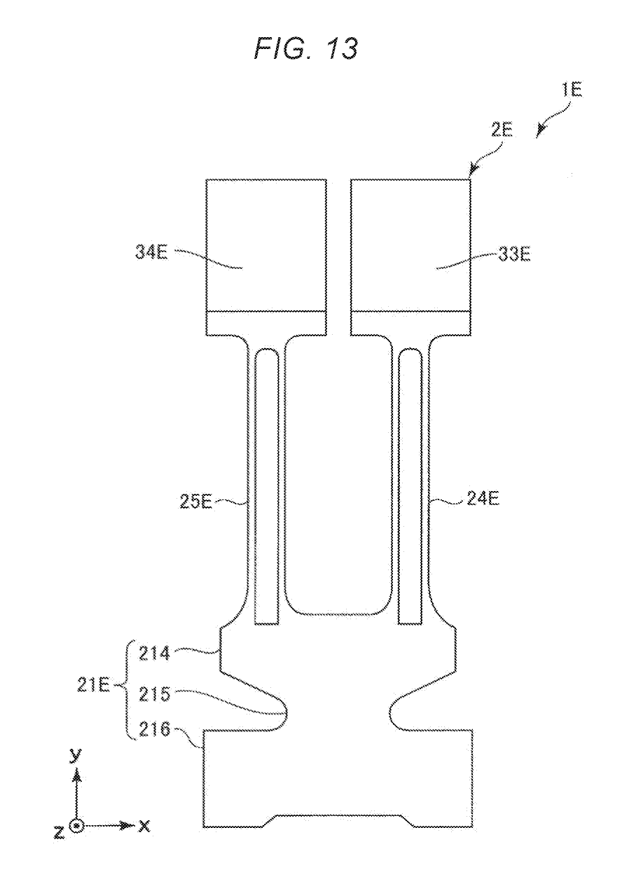

FIG. 13 is a plan view showing a vibrating element according to a third embodiment of the present disclosure.

The third embodiment will hereinafter be described focusing mainly on the differences from the embodiments described above, and the description of substantially the same matters will be omitted. It should be noted that in FIG. 13, the constituents substantially identical to those of the embodiment described above are denoted by the same reference symbols.

The present embodiment is substantially the same as the first embodiment described above except that the present disclosure is applied to a so-called two-legged tuning-fork vibrating element.

The vibrating element 1E shown in FIG. 13 is a sensor element for detecting the angular velocity around the y axis. The vibrating element 1E is provided with a vibrator element 2E, and the electrode films (not shown) and weight films 33E, 34E disposed on the vibrator element 2E.

The vibrator element 2E has a base 21E and a pair of vibrating arms 24E, 25E which are configured as a unit, and are formed using the Z-cut quartz crystal plate. It should be noted that the correspondence relationship between the crystal axes of the quartz crystal and the x axis, the y axis and the z axis is substantially the same as in the first embodiment described above.

The base 21E includes a first base 214 to which the vibrating arms 24E, 25E are coupled, a second base 216 disposed on the opposite side to the vibrating arms 24E, 25E with respect to the first base 214, and a coupling section 215 for coupling the first base 214 and the second base 216 to each other. The coupling section 215 is located between the first base 214 and the second base 216, and is smaller in width, namely the length in the x-axis direction, than the first base 214. Thus, it is possible to reduce the vibration leakage while reducing the length along the y-axis direction of the base 21E. Here, the second base 216 is supported by, for example, the package 11 described later.

The vibrating arms 24E, 25E each extend from the base 21E in the y-axis direction (the +y direction). The vibrating arms 24E, 25E are configured similarly to the drive arms in the first embodiment described above. Although not shown in the drawing, the vibrating arms 24E, 25E are each provided with a pair of drive electrodes for flexurally vibrating the vibrating arms 24E, 25E in the x-axis direction due to the energization, namely the drive signal electrode and the drive ground electrode, similarly to the drive arms 24 through 27 in the first embodiment described above. The pair of drive electrodes are electrically connected to terminals (not shown) on the base 21E via interconnections not shown.

Further, although not shown in the drawing, the vibrating arms 24E, 25E are each provided with a pair of detection electrodes for detecting a charge generated in accordance with the flexural vibration in the z-axis direction of the vibrating arms 24E, 25E, namely the detection signal electrode and the detection ground electrode, besides the pair of drive electrodes described above. The pair of detection electrodes are electrically connected to terminals (not shown) on the base 21E via interconnections not shown.

The weight films 33E, 34E are respectively disposed on the tip portions (the weight sections) of the vibrating arms 24E, 25E.

In the vibrating element 1E configured in such a manner, by applying the drive signal between the pair of drive electrodes, the vibrating arm 24E and the vibrating arm 25E flexurally vibrate (make the drive vibration) so as to repeat getting closer to and away from each other.

When the angular velocity ω around the y axis is applied to the vibrating element 1E in the state in which the vibrating arms 24E, 25E are kept making the drive vibration in such a manner, the vibration of bending toward the respective sides opposite to each other in the z-axis direction is excited due to the Coriolis force. Then, the charge generated between the pair of detection electrodes excited in such a manner is output from the pair of detection electrodes. The angular velocity ω applied to the vibrating element 1E can be obtained based on such a charge.

According also to such a present embodiment described hereinabove, it becomes possible to form the electrode films (not shown) and the weight films 33E, 34E in the same process similarly to the first embodiment described above, it is possible to achieve reduction of the manufacturing man-hour of the vibrating element 1E, and thus, it is possible to easily manufacture the vibrating element 1E.

### 2. Physical Quantity Sensor

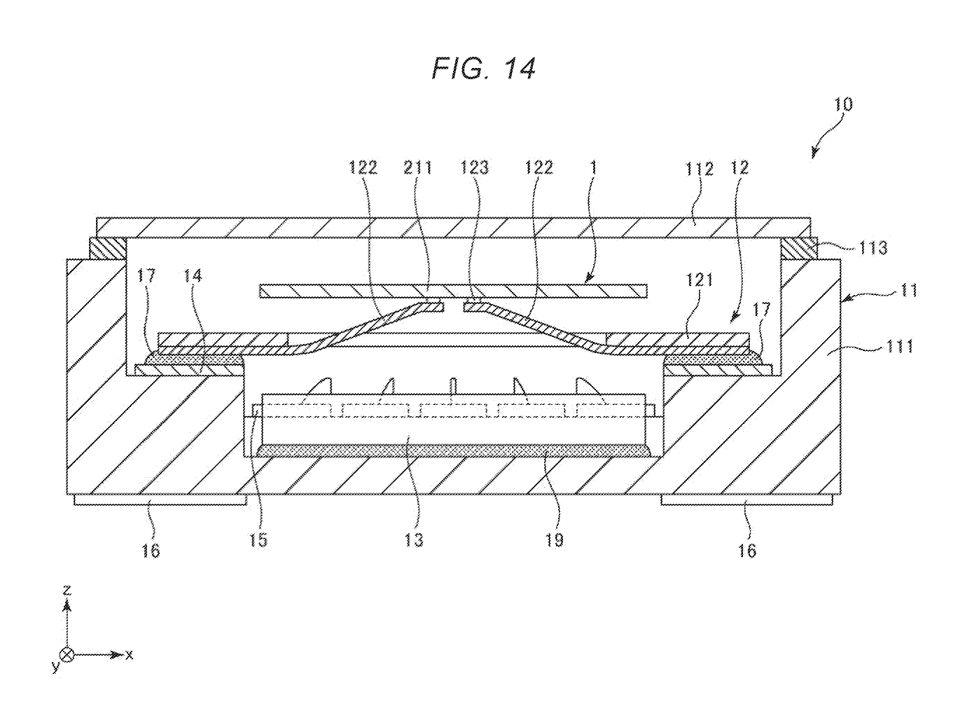

FIG. 14 is a cross-sectional view showing a physical quantity sensor according to an embodiment of the present disclosure.

The physical quantity sensor 10 shown in FIG. 14 is a vibratory gyro sensor for detecting the angular velocity around the z axis. The physical quantity sensor 10 has the vibrating element 1, 1D or 1E, the support member 12, the circuit element 13 (the integrated circuit chip), and the package 11 for housing these constituents.

The package 11 has a base 111 having a box-like shape provided with a recessed section for housing the vibrating element 1, and a lid 112 having a plate-like shape and bonded to the base 111 via a bonding member 113 so as to close the opening of the recessed section of the base 111. The inside of the package 11 can be kept in a reduced-pressure state including a vacuum state, or filled with an inert gas such as nitrogen, helium, or argon.

The recessed section of the base 111 has an upper surface located on the opening side, a lower surface located on the bottom side, and a middle surface located between these surfaces. The constituent material of the base 111 is not particularly limited, but a variety of types of ceramics such as aluminum oxide or a variety of types of glass materials can be used therefor. Further, the constituent material of the lid 112 is not particularly limited, but a member with a linear expansion coefficient similar to that of the constituent material of the base 111 is preferable. For example, in the case of using the ceramics described above as the constituent material of the base 111, an alloy such as Kovar is preferably used. Further, although a seam ring is used as the bonding member 113 in the present embodiment, the bonding member 113 can also be a member configured using, for example, low-melting-point glass or an adhesive.

On each of the upper surface and the middle surface of the recessed section of the base 111, there is disposed a plurality of connection terminals 14, 15. Some of the connection terminals 15 disposed on the middle surface are electrically connected to terminals 16 disposed on the bottom surface of the base 111 via an interconnection layer (not shown) provided to the base 111, and the rest are electrically connected to the plurality of connection terminals 14 disposed on the upper surface via interconnections (not shown). These connection terminals 14, 15 are not particularly limited as long as electrical conductively is provided, but are formed of a metal coating obtained by stacking a coat made of Ni (nickel), Au (gold), Ag (silver), Cu (copper), or the like on a metalization layer (a foundation layer) made of, for example, Cr (chromium) or W (tungsten).

The circuit element 13 is fixed to the lower surface of the recessed section of the base 111 with the adhesive 19 or the like. As the adhesive 19, it is possible to use, for example, an epoxy adhesive, a silicone adhesive, and a polyimide adhesive. The circuit element 13 has a plurality of terminals not shown, and these terminals are electrically connected to the respective connection terminals 15 disposed on the middle surface described above with electrically conductive wires. The circuit element 13 has a drive circuit for making the vibrating element 1 perform the drive vibration, and a detection circuit for detecting the detection vibration generated in the vibrating element 1 when the angular velocity is applied.

Further, the support member 12 is connected to the plurality of connection terminals 14 disposed on the upper surface of the recessed section of the base 111 via an electrically conductive adhesive 17. The support member 12 has interconnection patterns 122 connected to the electrically conductive adhesive 17, and a support substrate 121 for supporting the interconnection patterns 122. As the electrically conductive adhesive 17, it is possible to use an electrically conductive adhesive such as an epoxy adhesive, a silicone adhesive, or a polyimide adhesive mixed with an electrically conductive substance such as metal filler.

The support substrate 121 has an opening in the central part, and a plurality of elongated leads provided to the interconnection patterns 122 extends in the opening. To the tip portions of these leads, there is connected the vibrating element 1 via electrically conductive bumps 123.

It should be noted that although in the present embodiment, the circuit element 13 is disposed inside the package 11, it is also possible for the circuit element 13 to be disposed outside the package 11.

As described above, the physical quantity sensor 10 is provided with the vibrating element 1 and the package 11 housing the vibrating element 1. According to such a physical quantity sensor 10, it is possible to enhance the sensor characteristics of the physical quantity sensor 10 such as the detection accuracy and the const reduction using the excellent characteristics and the production easiness of the vibrating element 1.

### 3. Inertial Measurement Device

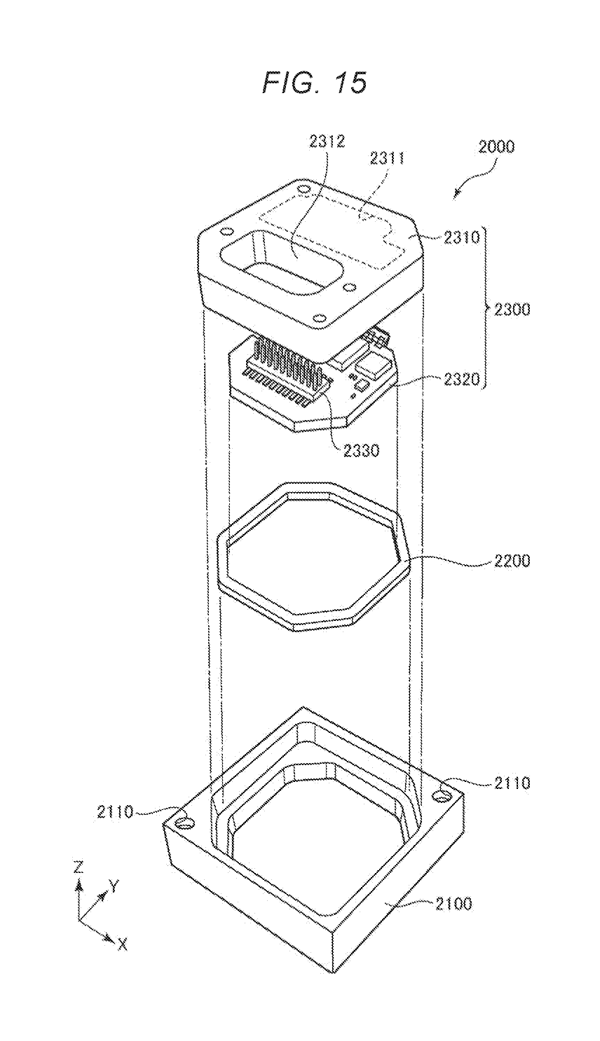

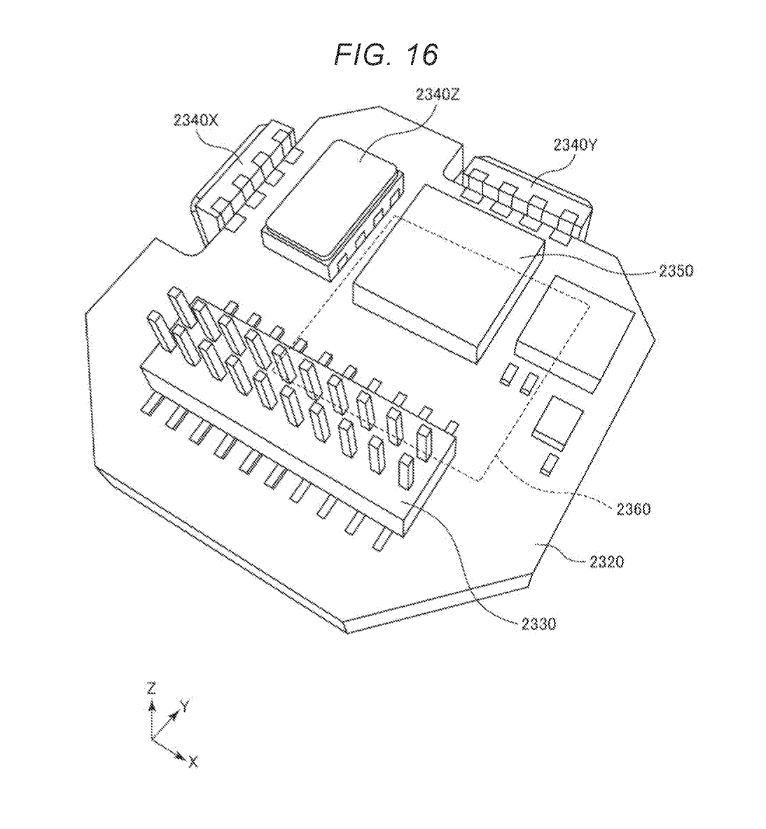

FIG. 15 is an exploded perspective view showing an embodiment of an inertial measurement device according to the present disclosure. FIG. 16 is a perspective view of a board provided to the inertial measurement device shown in FIG. 15.

The inertial measurement device (Inertial Measurement Unit (IMU)) 2000 shown in FIG. 15 is a so-called six-axis motion sensor, and is used while attached to a vehicle as a measurement object such as a car or a robot to detect an attitude and a behavior such as an amount of an inertial motion of the vehicle.

The inertial measurement device 2000 is provided with an outer case 2100, a bonding member 2200, and a sensor module 2300, and the sensor module 2300 is fitted or inserted into the outer case 2100 in the state in which the bonding member 2200 intervenes therebetween.

The outer case 2100 has a box-like shape, and on two corners located on a diagonal of the outer case 2100, there are disposed screw holes 2110 for fixing the outer case 2100 to the measurement object with screws.

The sensor module 2300 is provided with an inner case 2310 and the board 2320, and is housed inside the outer case 2100 described above in the state in which the inner case 2310 supports the board 2320. Here, the inner case 2310 is bonded to the outer case 2100 with an adhesive or the like via the bonding member 2200 such as a packing made of rubber. Further, the inner case 2310 has a recessed section 2311 functioning as a housing space for components to be mounted on the board 2320, and an opening part 2312 for exposing a connector 2330 disposed on the board 2320 to the outside. The board 2320 is, for example, a multilayer wiring board, and is bonded to the inner case 2310 with an adhesive or the like.

As shown in FIG. 16, on the board 2320, there are mounted the connector 2330, angular velocity sensors 2340X, 2340Y and 2340Z, an acceleration sensor 2350 and a control IC 2360.

The connector 2330 is electrically connected to an external device not shown, and is used for performing transmission and reception of electrical signals such as electrical power and measurement data between the external device and the inertial measurement device 2000.

The angular velocity sensor 2340X detects the angular velocity around the X axis, the angular velocity sensor 2340Y detects the angular velocity around the Y axis, and the angular velocity sensor 2340Z detects the angular velocity around the Z axis. Here, the angular velocity sensors 2340X, 2340Y and 2340Z are each the physical quantity sensor 10 described above. Further, the acceleration sensor 2350 is, for example, an acceleration sensor formed using the MEMS technology, and detects the acceleration in each of the axial directions of the X axis, the Y axis and the Z axis.

The control IC 2360 is a micro controller unit (MCU) incorporating a storage section including a nonvolatile memory, an A/D converter, and so on, and controls each section of the inertial measurement device 2000. Here, the storage section stores a program defining the sequence and the contents for detecting the acceleration and the angular velocity, a program for digitalizing the detection data to incorporate the result in the packet data, the associated data, and so on.

As described above, the inertial measurement device 2000 is provided with the physical quantity sensor 10, and the control IC 2360 as a circuit electrically connected to the physical quantity sensor 10. According to such an inertial measurement device 2000, it is possible to improve the characteristics such as the measurement accuracy of the inertial measurement device 2000, and at the same time achieve the cost reduction using the excellent sensor characteristics and the production easiness of the physical quantity sensor 10.

### 4. Electronic Apparatus

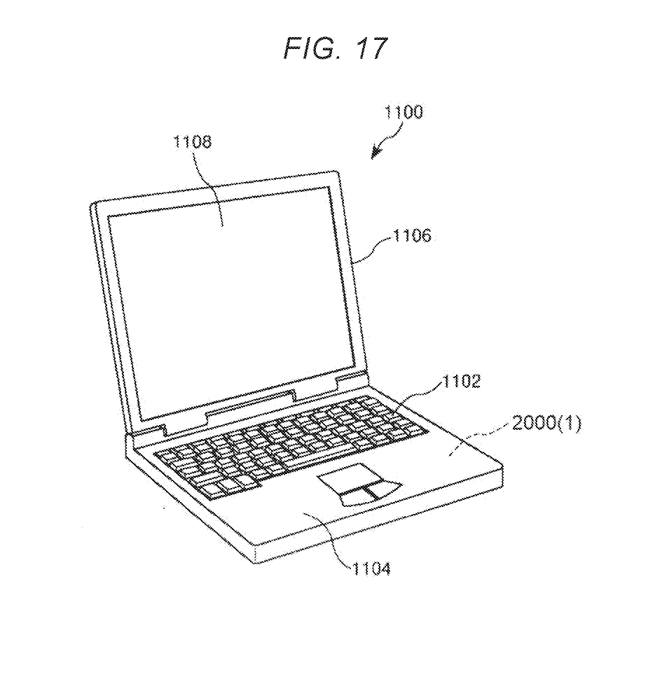

FIG. 17 is a perspective view showing a mobile type personal computer as an embodiment of the electronic apparatus according to the present disclosure.

In the drawing, the personal computer 1100 includes a main body 1104 provided with a keyboard 1102, and a display unit 1106 provided with a display 1108, and the display unit 1106 is pivotally supported with respect to the main body 1104 via a hinge structure. Such a personal computer 1100 incorporates the inertial measurement device 2000 including the vibrating element 1 described above.

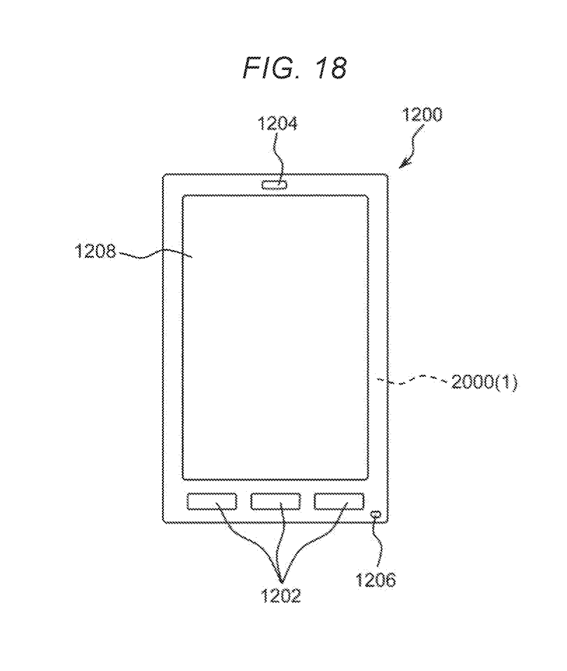

FIG. 18 is a plan view showing a mobile phone as an embodiment of the electronic apparatus according to the present disclosure.

In this drawing, the cellular phone 1200 is provided with an antenna (not shown), a plurality of operation buttons 1202, an ear piece 1204, and a mouthpiece 1206, and a display 1208 is disposed between the operation buttons 1202 and the ear piece 1204. Such a mobile phone 1200 incorporates the inertial measurement device 2000 including the vibrating element 1 described above.

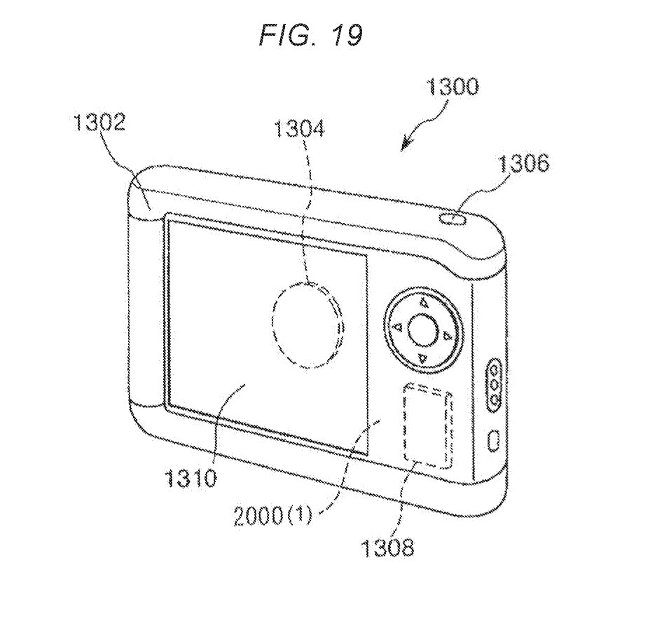

FIG. 19 is a perspective view showing a digital still camera as an embodiment of the electronic apparatus according to the present disclosure.

The case 1302 of the digital still camera 1300 is provided with a display 1310 disposed on the back surface thereof to have a configuration of performing display in accordance with the imaging signal from the CCD, wherein the display 1310 functions as a viewfinder for displaying the object as an electronic image. Further, the front surface, namely the back side in the drawing, of the case 1302 is provided with a light receiving unit 1304 including an optical lens, the CCD, and so on as an imaging optical system. Then, when the photographer checks an object image displayed on the display 1310, and then presses a shutter button 1306, the imaging signal from the CCD at that moment is transferred to and stored in a memory 1308. Such a digital still camera 1300 incorporates the inertial measurement device 2000 including the vibrating element 1 described above, and the measurement result of the inertial measurement device 2000 is used for, for example, image stabilization.

The electronic apparatuses described above are each provided with the vibrating element 1. According to such electronic apparatuses, it is possible to improve the characteristics such as reliability of the electronic apparatuses, and at the same time achieve the cost reduction using the excellent characteristics and the production easiness of the vibrating element 1.

It should be noted that, as the electronic apparatus according to the present disclosure, there can be cited, for example, a smartphone, a tablet terminal, a timepiece including a smart watch, an inkjet ejection device such as an inkjet printer, a wearable terminal such as a head-mounted display (HMD), a laptop personal computer, a television set, a video camera, a video cassette recorder, a car navigation system, a pager, a personal digital assistance including one with a communication function, an electronic dictionary, an electronic calculator, a computerized game machine, a word processor, a workstation, a video phone, a security video monitor, a pair of electronic binoculars, a POS terminal, medical equipment (e.g., an electronic thermometer, an electronic manometer, an electronic blood sugar meter, an electrocardiogram measurement instrument, an ultrasonograph, and an electronic endoscope), a fish detector, a variety of types of measurement instruments, a variety of types of gauges (e.g., gauges for a car, an aircraft, a ship or a boat), a base station for mobile terminals, and a flight simulator, besides the personal computer shown in FIG. 17, the mobile phone shown in FIG. 18, and the digital still camera shown in FIG. 19.

### 5. Vehicle

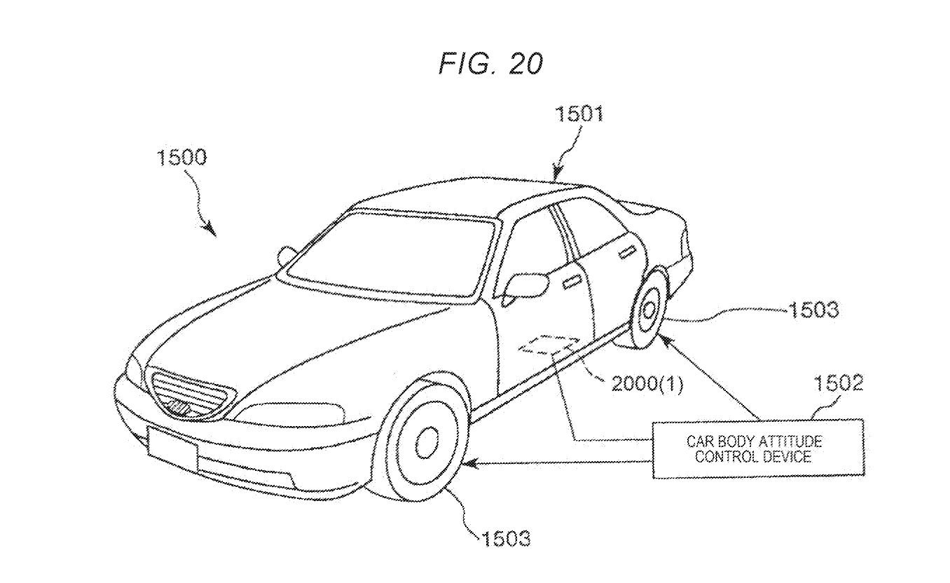

FIG. 20 is a perspective view showing a car as an embodiment of a vehicle according to the present disclosure.

The car 1500 incorporates the inertial measurement device 2000 including the vibrating element 1 described above, and the attitude of a car body 1501, for example, can be detected using the inertial measurement device 2000. The detection signal of the inertial measurement device 2000 is supplied to the car body attitude control device 1502, and it is possible for the car body attitude control device 1502 to detect the attitude of the car body 1501 based on the detection signal to thereby control the stiffness of the suspension or control the brake of each of wheels 1503 in accordance with the detection result.

Besides the above, such posture control as described above can be used for a two-legged robot, a radio control helicopter and a drone. As described hereinabove, in realizing the attitude control of a variety of types of vehicles, the inertial measurement device 2000 is incorporated.

As described hereinabove, the car 1500 as the vehicle is provided with the vibrating element 1. According to such a car 1500, it is possible to improve the characteristics such as reliability of the car 1500, and at the same time achieve the cost reduction using the excellent characteristics and the production easiness of the vibrating element 1.

Although the vibrating element, the method of manufacturing the vibrating element, the physical quantity sensor, the inertial measurement device, the electronic apparatus and the vehicle according to the present disclosure are hereinabove described based on the illustrated embodiments, the present disclosure is not limited to the embodiments, but the configuration of each of the constituents can be replaced with one having an identical function and an arbitrary configuration. Further, it is also possible to add any other constituents to the present disclosure.

Further, although in the embodiments described above, the vibrating element has the shape of a so-called double-T type, H type or two-legged tuning-fork type, this is not a limitation providing the element has a vibrating arm vibrating in an in-plane direction, and can have a variety of configurations such as a three-legged tuning-fork type, an orthogonal type, or a prismatic type.

What is claimed is:

1. A vibrating element comprising:
a base;
a vibrating arm extending from the base, and having
an arm section,
a weight section, and
a first principal surface and a second principal surface in an obverse-reverse relationship;
an electrode film disposed on each of the first principal surface and the second principal surface in the arm section, and having a thickness no less than 50 nm and no more than 500 nm; and
a weight film disposed on each of the first principal surface and the second principal surface in the weight section, and having a thickness no less than 50 nm and no more than 500 nm.

2. The vibrating element according to claim 1, wherein
on at least either one of the first principal surface and the second principal surface, the thickness of the electrode film in an area of the arm section continuous to the weight section is equal to the thickness of the weight film.

3. The vibrating element according to claim 1, wherein
the thickness of the electrode film disposed on the first principal surface is no less than 50% and no more than 200% of the thickness of the electrode film disposed on the second principal surface.

4. The vibrating element according to claim 1, wherein
the thickness of the weight film disposed on the first principal surface is no less than 50% and no more than 200% of the thickness of the weight film disposed on the second principal surface.

5. The vibrating element according to claim 1, wherein
the electrode film and the weight film each have a first film located on a vibrating arm side, and a second film which is located on an opposite side to the vibrating arm side of the first film, and which is thicker than the first film.

6. The vibrating element according to claim 5, wherein
the first film includes Cr, and the second film includes Au.

7. A method of manufacturing a vibrating element, comprising:
forming
a base,
a vibrating arm which extends from the base, which has an arm section and a weight section, and which has a first principal surface and a second principal surface in an obverse-reverse relationship,
an electrode film which is disposed on each of the first principal surface and the second principal surface in the arm section, and which has a thickness no less than 50 nm and no more than 500 nm, and
a weight film which is disposed on each of the first principal surface and the second principal surface in the weight section, and which has a thickness no less than 50 nm and no more than 500 nm; and
adjusting a resonance frequency of the vibrating arm by removing at least one of a part of the weight film and a part of the electrode film by irradiation with an energy beam.

8. The method according to claim 7, wherein
the adjusting the resonance frequency of the vibrating arm is removing at least one of a part of the electrode film and a part of the weight film disposed on the first principal surface, while removing at least one of a part of the electrode film and a part of the weight film disposed on the second principal surface.

9. The method according to claim 7, wherein
the adjusting the resonance frequency of the vibrating arm is removing at least one of a part of the electrode film and a part of the weight film disposed on the first principal surface, then housing the vibrating arm in a package, and then removing at least one of a part of the electrode film and a part of the weight film disposed on the second principal surface.

10. A physical quantity sensor comprising:
the vibrating element according to claim 1; and
a package configured to house the vibrating element.

11. An inertial measurement device comprising:
the physical quantity sensor according to claim 10; and
a circuit electrically connected to the physical quantity sensor.

12. An electronic apparatus comprising:
the vibrating element according to claim 1; and
a circuit configured to output a drive signal to the vibrating element.

13. A vehicle comprising:
the vibrating element according to claim 1; and
a body equipped with a physical quantity sensor provided with the vibrating element.
